(19) United States
(12) Patent Application Publication
(10) Pub. No.: US 2014/0071341 A1
(43) Pub. Date: Mar. 13, 2014

(54) GRIP MEMBER AND IMAGE PICKUP DEVICE

(71) Applicant: Sony Corporation, Minato-ku (JP)

(72) Inventor: Noriaki TAKAGI, Kanagawa (JP)

(21) Appl. No.: 13/937,706

(22) Filed: Jul. 9, 2013

(30) Foreign Application Priority Data
Sep. 10, 2012 (JP) 2012-198595

(51) Int. Cl. H04N 5/225

(52) U.S. Cl. CPC H04N 5/2252
USPC 348/375; 16/429

(57) ABSTRACT

A grip member includes: an attachment section to be attached to a body; an extension section configured to be displaceable with respect to the body; and a linkage section linking the attachment section with the extension section.

### BACKGROUND

The present disclosure relates to a grip member that is suitable for use in an image pickup device, such as a small-sized camera and the like, as well as to an image pickup device that includes such a grip member.

For some image pickup devices, such as a small-sized camera and the like, a spatular accessory with a front edge thereof curved is mounted on a body to improve the easiness of grasping in a manner of holding a thumb on this accessory (for example, see the nonpatent document 1: “Item for Improving Hold Feeling of Digital Camera with Thumb”, [online], Oct. 17, 2011, “excite news”, [searched on Aug. 21, 2012], Internet URL: http://www.excite.co.jp/News/bit/E1318411438584.html).

### SUMMARY

For such an accessory, however, a portion for putting a thumb on is fixed, which has often caused operation of a body to be disturbed.

It is desirable to provide a grip member capable of improving the easiness to grasp a body without disturbing operation of the body, and an image pickup device that includes such a grip member.

According to an embodiment of the present disclosure, there is provided a grip member including: an attachment section to be attached to a body; an extension section configured to be displaceable with respect to the body; and a linkage section linking the attachment section with the extension section.

In the grip member according to the above-described embodiment of the present disclosure, a thumb may be held on the extension section with a palm laid on a side face of the body, which makes it easy to grasp the body. The extension section is displaced as appropriate, thereby reducing a possibility that the extension section will disturb operation of the body.

According to an embodiment of the present disclosure, there is provided an image pickup device including: a body; and a grip member configured to be mounted on a top face of the body and including an extension section, the extension section being configured to be displaceable with respect to the body.

In the image pickup device according to the above-described embodiment of the present disclosure, grasping of the body is aided by the grip member according to the above-described embodiment of the present disclosure, and intended operation, such as image pickup and the like is carried out by the body.

In the grip member and the image pickup device according to the above-described respective embodiments of the present disclosure, the extension section is capable of being displaced with respect to the body, which makes it possible to improve the easiness to grasp the body without disturbing operation of the body.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a perspective view showing a configuration of an image pickup device according to one embodiment of the present disclosure.

FIG. 2 is a perspective view showing an enlarged view of the grip member illustrated in FIG. 1.

FIG. 3 is a perspective view showing displacement of the extension section illustrated in FIG. 1.

FIG. 4 is a perspective view showing a state where the extension section illustrated in FIG. 1 is moved pivotally to a second position.

FIG. 5 is a perspective view showing a configuration of the grip member illustrated in FIG. 1 that is seen in an upside down state.

FIG. 6 is a perspective view showing an operational state of a lock mechanism of the grip member illustrated in FIG. 3.

FIG. 7 is a cross-sectional view showing the operational state illustrated in FIG. 6.

FIG. 8 is a perspective view showing an unlocked state of the lock mechanism illustrated in FIG. 6.

FIG. 9 is a cross-sectional view showing the unlocked state illustrated in FIG. 8.

FIG. 10 is a perspective view for explaining an operation during the image-pickup time.

FIG. 11 is a perspective view for explaining an operation during the non-image-pickup time.

FIG. 12 is a perspective view for explaining an operation in a case where a user wants to perform a playback or mode settings in the middle of the image pickup.

FIG. 13 is a first perspective view in a case where the image pickup device is seen from the rear side.

FIG. 14 is a second perspective view in a case where the image pickup device is seen from the rear side.

FIG. 15 is a rear view of the image pickup device.

FIG. 16 is a top view of the image pickup device.

### DETAILED DESCRIPTION

Hereinafter, some embodiments of the present disclosure are described in details with reference to the drawings.

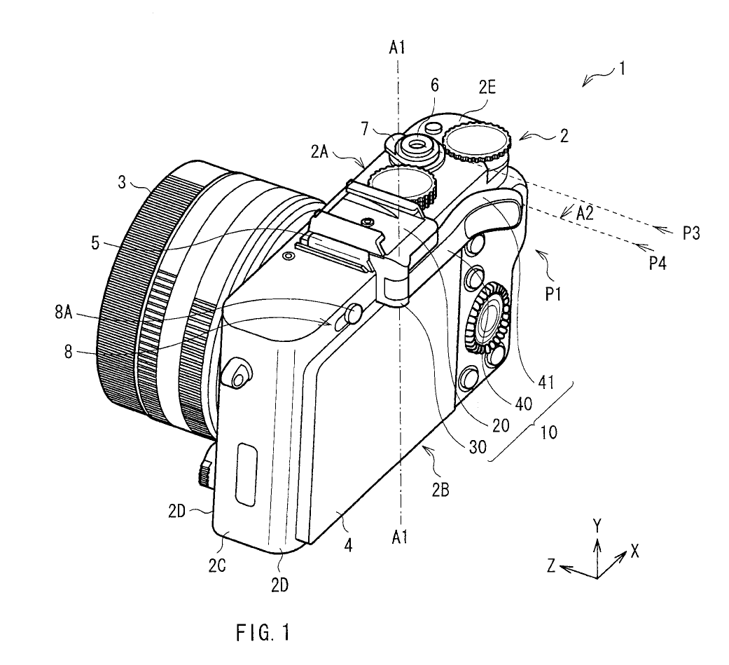

FIG. 1 shows a configuration of an image pickup device according to one embodiment of the present disclosure. This image pickup device 1 may be, for example, a small-sized image pickup device, such as a compact digital camera and the like, and has a body 2 in the approximately cuboid form.

In the descriptions and drawings to be given hereinafter, an anteroposterior direction (Z), a vertical direction (Y), and a horizontal direction (X) are shown in a direction being viewed by a photographer at the time of shooting by the use of the image pickup device 1. Therefore, a photographic subject side is a front side, and a photographer side is a rear side. It is to be noted that the anteroposterior direction (Z), the vertical direction (Y), and the horizontal direction (X) are meant only for descriptive purpose, and embodiments of the present disclosure are not limited to these directions.

The body 2 takes a plate-like shape with a grip portion (right side portion) having no or slight bulge. A front face 2A and a rear face 2B of the body 2 are both flat or substantially flat. At each corner in longitudinal sides of a side face 2C on the body 2, there is provided a curved face 2D. It is to be noted that the curved face 2D may not be necessarily provided.

At the front face 2A of the body 2, there is attached a lens barrel 3. Within the lens barrel 3, there are arranged along an optical axis a photographic lens (not shown in the figure) for performing subject imaging, a lens or a lens group that is served as an image pickup optical system (not shown in the figure), and an image pickup element (not shown in the figure). The image pickup element may be configured of, for example, a CCD (Charge Coupled Device) image sensor or a CMOS (Complementary Metal Oxide Semiconductor) image sensor.

At the rear face 2B of the body 2, there is arranged a display section 4. The display section 4 may be a display unit of, for example, a liquid crystal or an organic EL (Electroluminescence) type.

At a top face 2E of the body 2, there are provided, for example, an accessory shoe 5 and a shutter button 6. The accessory shoe 5 is arranged at a slightly leftward position in the center of the top face 2E on the body 2. The shutter button 6 is arranged at a slightly rightward position at the front side of the top face 2E on the body 2. At an outer circumference of the shutter button 6, there is provided a power knob 7.

The accessory shoe 5, which may be, for example, a hot shoe capable of electric conduction that has terminals (not shown in the figure), enables connection of external members involving electric conduction, such as an external flash device and an EVF (electronic viewfinder). However, the accessory shoe 5 may be alternatively a non-electric-conduction cold shoe having no terminals.

Further, the accessory shoe 5 is provided with a grip member 10 that is attached thereto. The grip member 10, which is an accessory that is attached to the body 2 of the image pickup device 1 to aid grasping of the body 2 (or a so-called “thumb grip”), has an extension section 40 as a portion for holding a thumb on at the rear face 2B side of the body 2. The extension section 40 is capable of being displaced with respect to the body 2. In the grip member 10, this makes it possible to improve the easiness to grasp the body 2 without disturbing operation of the body 2.

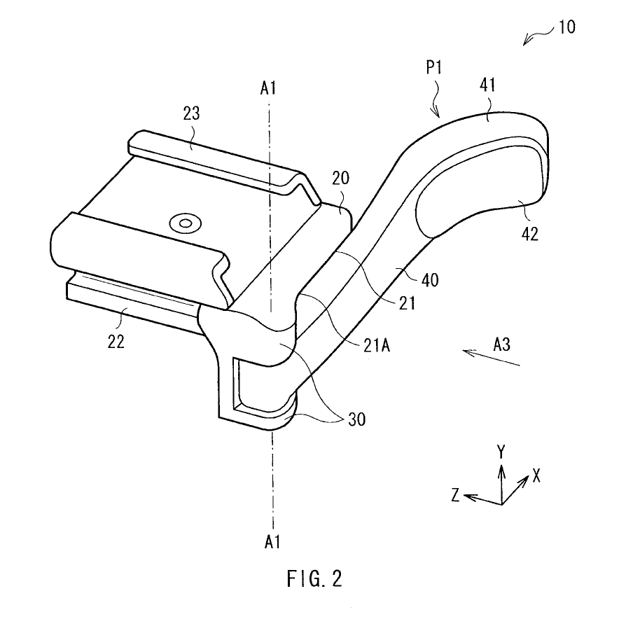

As shown in an example in FIG. 2 as an enlarged view, the grip member 10 has an attachment section 20 and a linkage section 30. The attachment section 20 is a portion to be attached to the body 2. The linkage section 30, which is a portion to link the attachment section 20 with the extension section 40, is fixed to the attachment section 20. The extension section 40 is capable of being displaced with respect to the linkage section 30, which ensures accordingly that it is capable of being displaced with respect to the body 2 as described above.

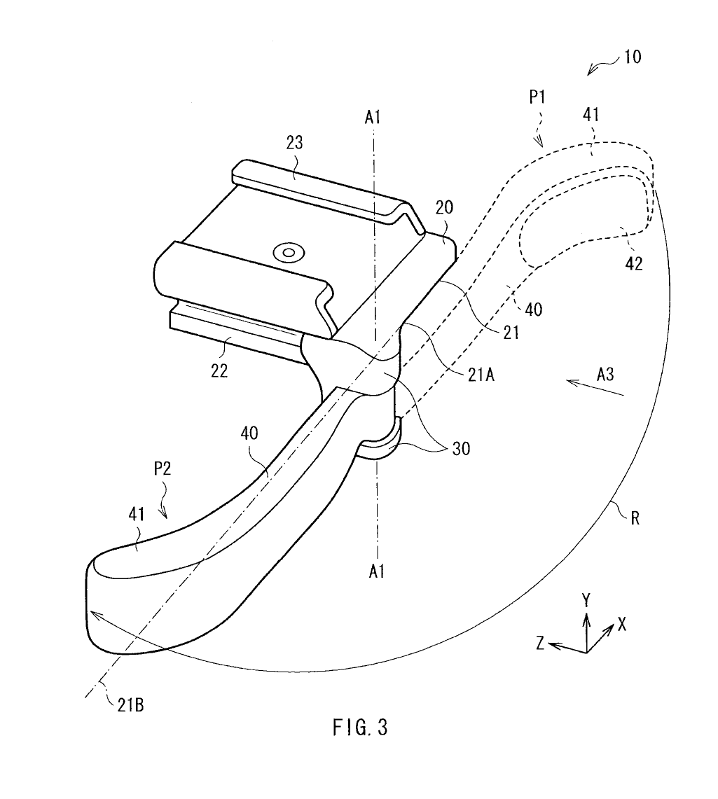

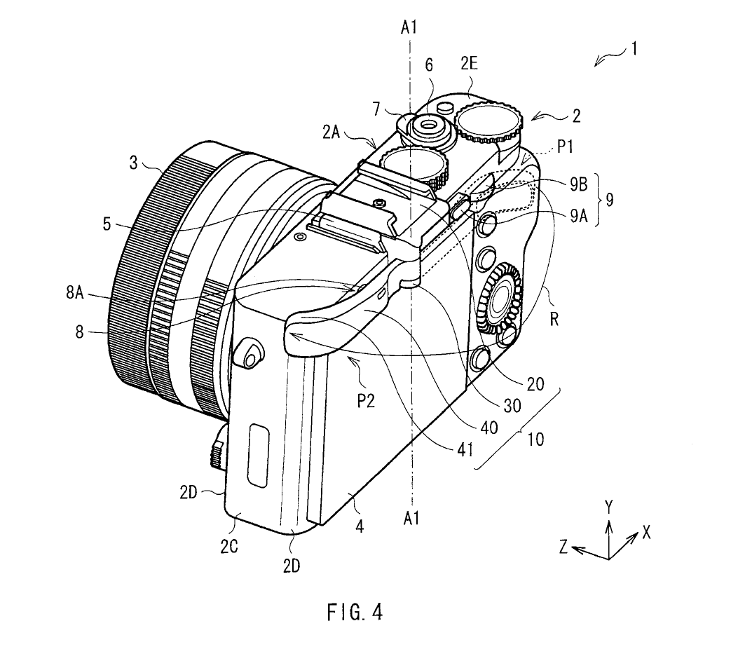

Each of FIG. 3 and FIG. 4 shows a displacement of the extension section 40. The extension section 40 may preferably be pivotable as indicated by an arrow R in FIG. 3 around the linkage section 30 as an axis A1. Such a pivotal movement of the extension section 40 in the X-Z in-plane direction around the axis A1 eliminates the necessity for any mechanism and the like to adjust a position or a length of the extension section 40 for fixing, which allows a configuration of the linkage section 30 to be made simple. Further, this reduces the possibility that a position of the extension section 40 will shift from side to side during the shooting to pose a trouble for the shooting, thereby allowing a comfortable image pickup to be achieved.

In concrete terms, as shown in FIG. 3, the linkage section 30 is provided to extend from one end 21A of a side 21 on the attachment section 20 to a direction intersecting with (for example, orthogonal to) the attachment section 20. In other words, given that a plane including the attachment section 20 is the X-Z plane, the axis A1 (linkage section 30) for pivotal movement of the extension section 40 is provided in the vertical direction (Y direction). The extension section 40 is capable of moving pivotally around the linkage section 30 as the axis A1 between a first position P1 overlapping with the side 21 on the attachment section 20 and a second position P2 overlapping with an extension line 21B of the side 21 on the attachment section 20.

The first position P1 is a position for making it easy to grasp the body 2 by helping to hold a thumb on a finger-holding section 41 at the front edge of a movable side of the extension section 40. Preferably, the finger-holding section 41 may have a curved form protruding backward in Z direction to make it easy to hold a thumb.

On the other hand, the second position P2 is a position that throws open operation buttons and the like on the body 2 that have been hidden by the extension section 40 located at the first position P1 to make those operation component parts easily operable. Further, as described later, the extension section 40, when located at the second position P2, is allowed to have a curved form that fits in with an outline (that is, curved face 2D) of the body 2, and to ensure that the image pickup device 1 with the grip member 10 attached is put in a case (not shown in the figure) and the like, which reduces the possibility that the detached grip member 10 will be missing. Moreover, when a viewfinder (not shown in the figure) is attached to a later-described accessory shoe 23 on the attachment section 20, and a user with spectacles on takes a look inside the viewfinder, it is possible to ensure that the curved finger-holding section 41 does not cumber the image pickup by retracting the extension section 40 to the second position P2.

A displacement range (pivotal movement range) of the extension section 40 may preferably lie above the display section 4 at the rear face 2B of the body 2, including the first position P1 and the second position P2, as shown in FIG. 1 and FIG. 4. This makes it possible to minimize any interference between the extension section 40 and the display section 4 that may be caused due to a pivotal movement of the extension section 40. Further, when a viewfinder (not shown in the figure) is attached to the later-described accessory shoe 23 on the attachment section 20, it is also possible to minimize any interference between the extension section 40 and the viewfinder that may be caused due to a pivotal movement of the extension section 40.

Preferably, on the body 2, the operation buttons and the like may be arranged in association with a pivotal movement position of the extension section 40. More specifically, as shown in FIG. 1 and FIG. 4, the body 2 has a first operation section 8 and a second operation section 9 on the upper side of the display section 4 at the rear face 2B. The first operation section 8 is used mainly at the image-pickup time, being opened when the extension section 40 is located at the first position P1, while being hidden when the extension section 40 is located at the second position P2. The second operation section 9 is used mainly at the non-image-pickup time (for example, at the playback time), being opened when the extension section 40 is located at the second position P2, while being hidden when the extension section 40 is located at the first position P1. This throws open the relevant operation buttons depending on a pivotal movement position of the extension section 40, thereby allowing the convenience for a user to be further improved. Moreover, with an increase in the number of buttons that is commensurate with the complicated operation system in addition to miniaturization of the body 2 in line with advances in the device technology, there is a possibility that the necessity for arranging the operation buttons and the like at the bottom of the extension section 40 as well will arise. The grip member 10 is quite suitable for addressing such a possibility.

In concrete terms, the first operation section 8 may include, for example, a flash operation button 8A. The flash operation button 8A pops up a flash device (not shown in the figure) that is built in the body 2 from the top face 2E of the body 2.

The second operation section 9 may include, for example, a playback button 9A and an electronic dial 9B. The playback button 9A displays on the display section 4 subject images that are imaged with an image pickup lens (not shown in the figure) of the lens barrel 3, or images that are taken by the image pickup element (not shown in the figure). The electronic dial 9B has a variety of functions, including a function that enables a user to specify and select a shutter speed or an exposure compensation (EV value).

Hereinafter, the descriptions are provided on more detailed configuration of the attachment section 20, the linkage section 30, and the extension section 40 of the grip member 10.

The attachment section 20 may preferably be mounted on the top face 2E of the body 2 as shown in FIG. 1. In concrete terms, preferably, the attachment section 20 may be mounted on the top face 2E of the body 2 in a manner of being inserted into the accessory shoe 5 as described above. This is because there is a possibility that the attachment section 20 will be unable to hold up a force of a thumb to be applied to the extension section 40 due to a significantly strong force of a thumb to be applied to the extension section 40 when the attachment section 20 is mounted at any other locations on the body 2 (for example, on the rear face 2B or the side face 2C) by means of a hinge (joint) and the like. In particular, the accessory shoe 5 has a strength to ensure that an external large-sized flash device does not drop off due to, for example, falling or mechanical shock, and thus is capable of fully holding up a force of a thumb to be applied to the extension section 40.

Preferably, the attachment section 20 may be detachable from the body 2, although it may be fixed to, or integrated with the body 2, and may be undetachable alternatively.

As shown in an example in FIG. 2, the attachment section 20 may have a connection section 22 and an accessory shoe 23. The connection section 22 is a portion to be inserted into the accessory shoe 5 at the body 2 side. The accessory shoe 23 is provided on the top face of the connection section 22 for substitution and supplement of the accessory shoe 5 at the body 2 side. The accessory shoe 23, which may be, for example, a cold shoe, enables connection of external members involving no electric conduction, such as an OVF (Optical Viewfinder) and the like. However, the accessory shoe 23 may be alternatively a hot shoe as with the accessory shoe 5 at the body 2 side.

The linkage section 30 is provided vertically on the lower side from one end 21A of the side 21 on the attachment section 20 at the rear face 2B side of the body 2, and passes through a first end (a front edge of an axis side, i.e., a pivotable end) of the extension section 40 in the vertical direction (Y direction), having a functionality as the axis A1 for a pivotal movement of the extension section 40. A second end (a front edge of a movable side, i.e., a free end) of the extension section 40 is served as the above-described finger-holding section 41.

Preferably, a length of the extension section 40 (position P4 of the finger-holding section 41) may satisfy, for example, the following requirements.

First, when the extension section 40 is located at the first position P1, the finger-holding section 41 may preferably be located at a position closer to the linkage section 30 than a specific position P3 (for example, shutter button 6) on the face (that is, top face 2E) where the attachment section 20 of the body 2 is mounted (see an arrow A2 in FIG. 1). One reason is as follows. An ideal position of a thumb in grasping the body 2 is right behind the shutter button 6, although in practice, it brings a more excellent comfort level or a feeling of security to hold a thumb more deeply (closer to the center) than the ideal position. Therefore, when the extension section 40 is located at the first position P1, the finger-holding section 41 may preferably be located at a position closer to the linkage section 30 than the specific position P3 (shutter button 6) on the top face 2E of the body 2.

Secondly, the finger-holding section 41 may preferably be located at a position where a thumb is not put on the display section 4 at the time of holding the thumb thereon. This is because a thumb is put on the display section 4 (or a thumb shadow is reflected on the display section 4) to make the display section 4 less visible, which will possibly cause trouble to shooting. However, it does not pose a significant trouble to put a thumb on a black region of a frame on the display section 4. Preferably, a thumb may be not put on an inner region (display region) from the black region on the display section 4.

Thirdly, when the extension section 40 is located at the second position P2, the finger-holding section 41 may preferably have a curved form that fits in with an outline (that is, curved face 2D) of the body 2 as shown in FIG. 4. This makes it possible to put the image pickup device 1 in a case (not shown in the figure) and the like with the grip member 10 attached, which reduces the possibility that the detached grip member 10 will be missing in putting the image pickup device 1 in a case.

As shown in FIG. 2, the finger-holding section 41 may preferably be provided with a nonslip section 42. This makes it possible to assuredly put a thumb on the finger-holding section 41 and to stably grasp the body 2. Further, in making the extension section 40 move pivotally to the second position P2, the nonslip section 42 comes in contact with the body 2 at the beginning, which allows to prevent any coating peel-off or damage of the body 2. Examples of a material for the nonslip section 42 may include a resin such as rubber and elastomer, a cushioning material, a leather, and the like. Alternatively, the nonslip section 42 may be subject to a surface treatment, including roughing of the front surface of the finger-holding section 41.

As shown in FIG. 2 and FIG. 3, the linkage section 30 may preferably be provided to extend from the left end 21A of the side 21 on the attachment section 20 when viewed from the backside of an insertion direction A3 into the accessory shoe 5 of the attachment section 20. This allows a position of the finger-holding section 41 to satisfy the above-described first to third requirements. Further, when the extension section 40 is located at the first position P1, the extension section 40 overlaps with the side 21 on the attachment section 20, which makes it possible to assuredly hold up a strong force of a thumb to depress the extension section 40.

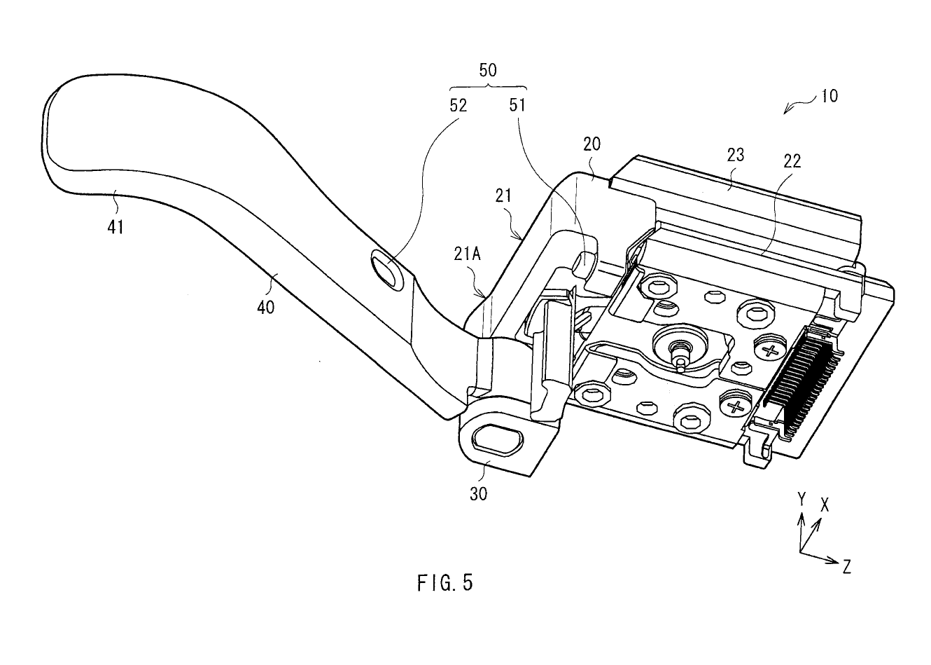

FIG. 5 shows a configuration of the grip member 10 illustrated in FIG. 1 that is seen in an upside down state. The grip member 10 is provided with a restricting section 50 that holds the extension section 40 at the first position P1. The restricting section 50 may have, for example, a convex portion 51 that is provided on the linkage section 30 and a concave portion 52 that is provided on the extension section 40. The convex portion 51 is fitted into the concave portion 52 when the extension section 40 is located at the first position P1. This prevents the extension section 40 from moving pivotally beyond the first position P1 to unintentionally depress the operation buttons and the like on the body 2, or avoids any coating peel-off or damage of the body 2. Further, when the extension section 40 is located at the first position P1, it is possible to suppress any rattling in the vertical and horizontal directions of the extension section 40, in particular a rattling in the vertical direction.

It is to be noted that FIG. 5 illustrates a case where, in the restricting section 50, the convex portion 51 is provided on the linkage section 30, and the concave portion 52 is provided on the extension section 40, although the convex portion 51 may be provided on the extension section 40, and the concave portion 52 may be provided on the linkage section 30. Further, when the extension section 40 is located at the second position P2, the side face 2C and the curved face 2D of the body 2 are allowed to have a functionality as a restricting section to hold the extension section 40 at the second position P2.

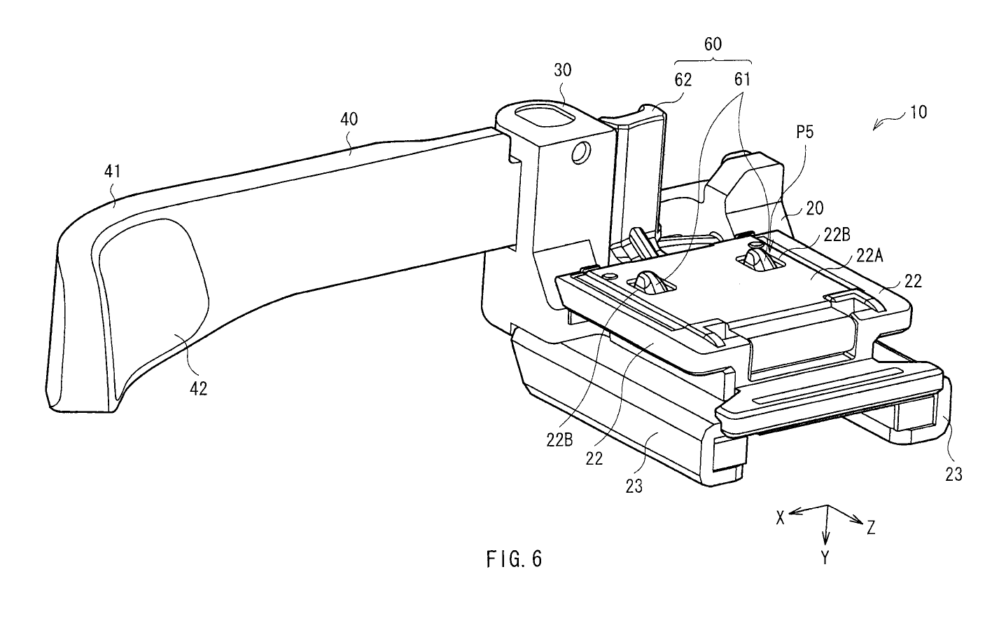

Preferably, the attachment section 20 may have a lock mechanism to prevent any drop-off from the accessory shoe 5. As shown in an example in FIG. 6, this lock mechanism 60 has two protrusions 61 and a lever 62 to move those two protrusions 61. Two protrusions 61 are provided inside holes 22B on a bottom face 22A of the connection section 22. On the other hand, on a bottom face 5A of the accessory shoe 5 on the body 2, there are provided holes 5B at positions opposite to those two protrusions 61.

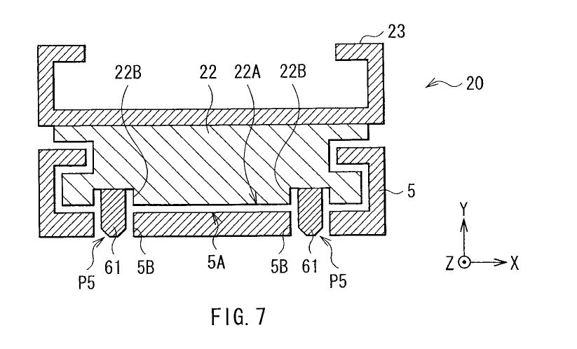

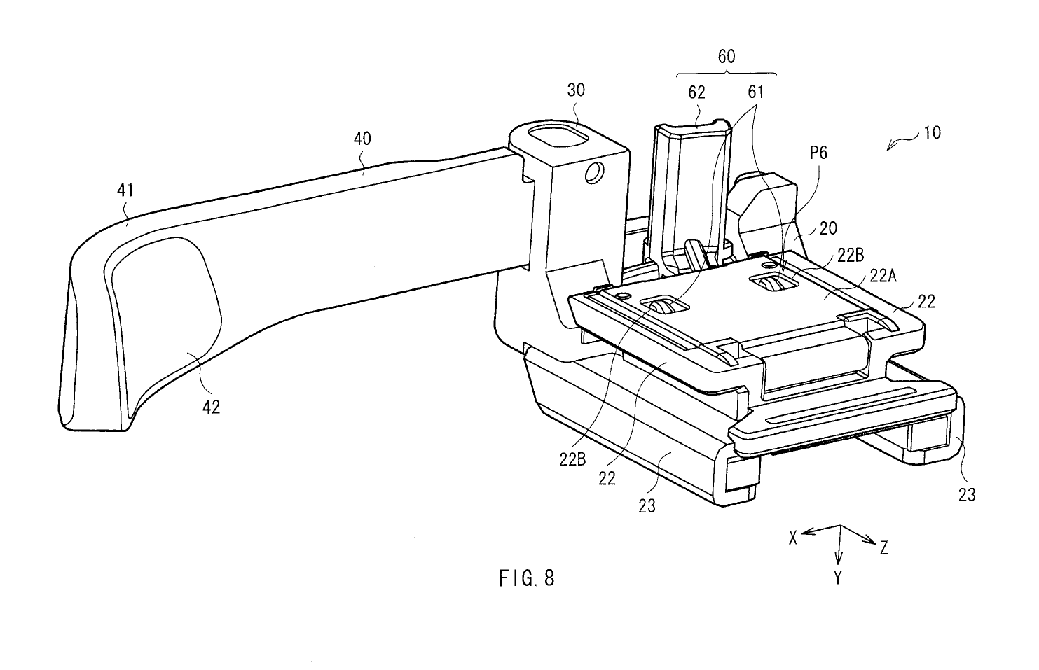

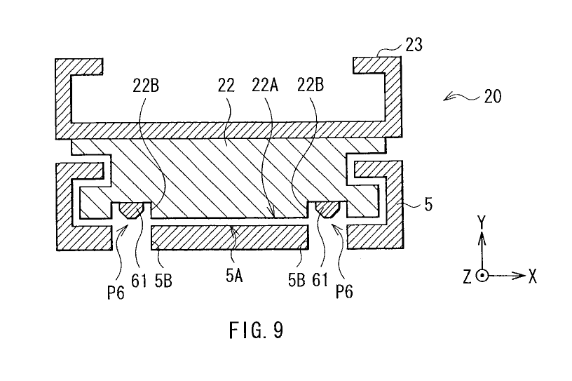

Two protrusions 61 are capable of reciprocating in the vertical direction (Y direction) between a working position P5 (see FIG. 6 and FIG. 7) and a release position P6 (see FIG. 8 and FIG. 9). At the working position P5, two protrusions 61 protrude from the holes 22B on the bottom face 22A of the connection section 22 to be latched into the holes 5B on the bottom face 5A of the accessory shoe 5. At the release position P6, two protrusions 61 are placed inside the holes 22B on the bottom face 22A. For example, the lever 62 may be capable of reciprocating in the horizontal direction (X direction) along the side 21 of the attachment section 20, and may come in contact with the linkage section 30 at the working position P5, while getting away from the linkage section 30 at the release position P6.

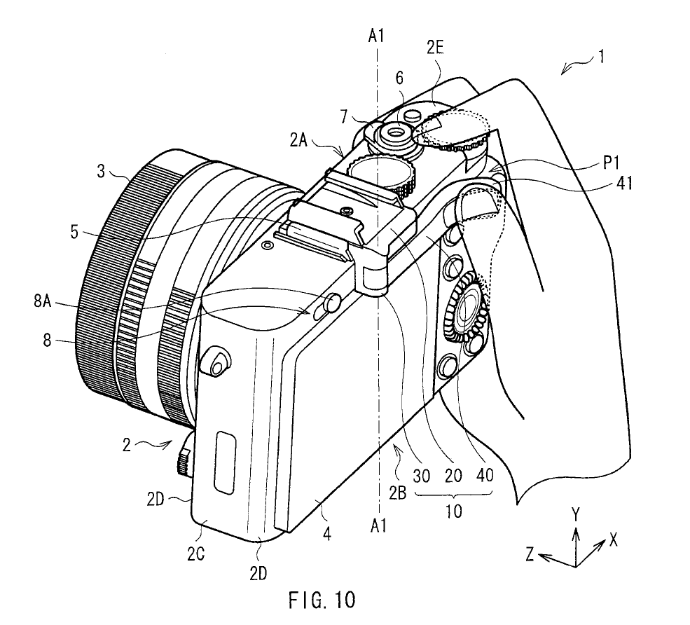

Hereinafter, with reference to FIG. 10 to FIG. 12, the descriptions are provided on the operation and function of the image pickup device 1.

First, the attachment section 20 of the grip member 10 is mounted on the accessory shoe 5 on the top face 2E of the body 2. On this occasion, with the protrusions 61 of the lock mechanism 60 placed at the release position P6 as shown in FIG. 8 and FIG. 9, the connection section 22 is inserted into the accessory shoe 5. Subsequently, the protrusions 61 are placed at the working position P5 as shown in FIG. 6 and FIG. 7 by operating the lever 62, and those two protrusions 61 are latched into the holes 5B on the bottom face 5A of the accessory shoe 5, thereby preventing the grip member 10 from dropping off from the accessory shoe 5.

At the time of the image pickup, as shown in an example in FIG. 10, the extension section 40 is located at the first position P1, and a thumb is held on the finger-holding section 41 with a palm laid on the side face 2C of the body 2. This makes it easy to grasp the body 2, which enables comfortable image pickup without causing any concerns about falling of the body 2 and the like.

When the grip member 10 is attached to the body 2, a part of the operation buttons and the like on the body 2 (first operation section 8 or second operation section 9) is hidden by the extension section 40. In concrete terms, as shown in FIG. 10, when the extension section 40 is located at the first position P1, the first operation section 8 (flash operation button 8A) is left open to be easily operable, although the second operation section 9 (playback button 9A and electronic dial 9B) is hidden.

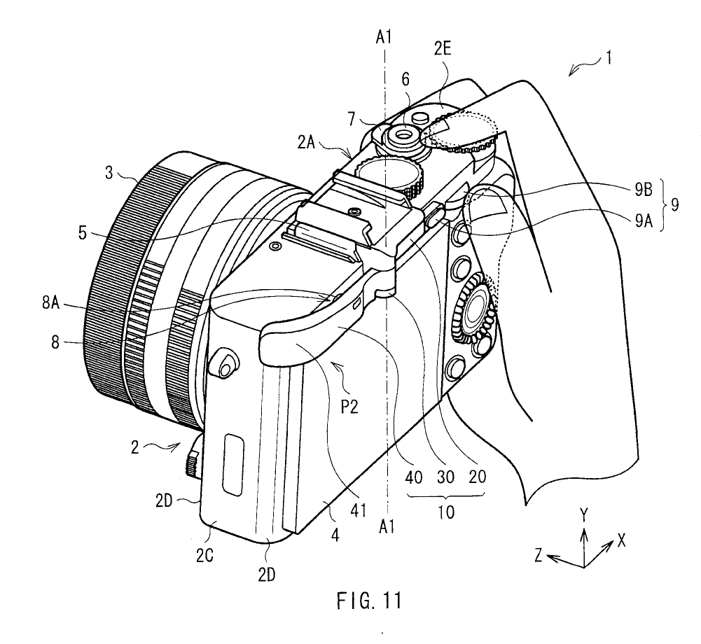

The extension section 40 is capable of being displaced with respect to the body 2 (linkage section 30), and thus the operation buttons and the like on the body 2 that are hidden by the extension section 40 are left open to be easily operable by displacing the extension section 40 as appropriate. In concrete terms, as shown in an example in FIG. 11, by making the extension section 40 move pivotally to the second position P2, the first operation section 8 (flash operation button 8A) is hidden, although the second operation section 9 (playback button 9A and electronic dial 9B) is left open to be easily operable. This allows the first operation section 8 and the second operation section 9 to be switched to be open with the grip member 10 attached, which removes the burden of detaching the grip member 10 all of the time.

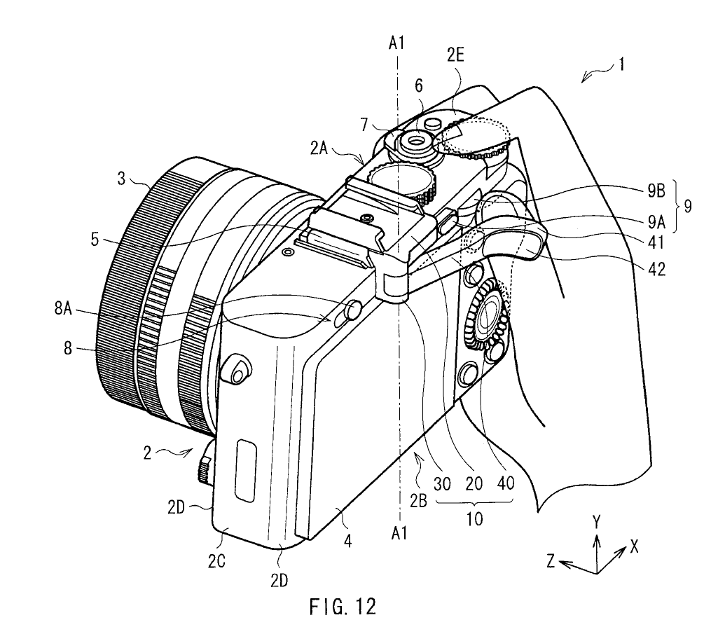

Further, as shown in an example in FIG. 12, when a thumb is inserted between the finger-holding section 41 and the body 2, the extension section 40 stops a pivotal movement at a narrow angle permitting only insertion of a thumb. It is possible to adjust such a stop of a pivotal movement of the extension section 40 at a narrow angle by means of, for example, a shape of a cam (not shown in the figure) inside the linkage section 30. Therefore, when a user wants to perform playback or change settings in the middle of shooting, he/she has only to insert a thumb into a clearance gap between the finger-holding section 41 and the body 2 without the necessity for making the extension section 40 fully move pivotally to the second position P2. Further, on this occasion, a curved form of the finger-holding section 41 is allowed to also have a guide functionality that makes it easy to insert a thumb into a clearance gap between the finger-holding section 41 and the body 2. Thereafter, by putting a thumb on the finger-holding section 41 again, it is possible to immediately return the extension section 40 back to the first position P1 for resuming the shooting.

After the end of shooting, by making the extension section 40 move pivotally to the second position P2, it is possible to fit the extension section 40 in line with an outline (that is, curved face 2D) of the body 2, and to put the image pickup device 1 in a case (not shown in the figure) and the like with the grip member 10 attached. As a result, in putting the image pickup device 1 in a case, this removes any trouble of detaching the grip member 10 and reduces the possibility that the detached grip member 10 will be missing.

As described above, in the grip member 10 according to this embodiment of the present disclosure, the extension section 40 is capable of being displaced with respect to the body 2, and thus it is possible to improve the easiness to grasp the body 2 without disturbing operation of the body 2. Therefore, configuration of the image pickup device 1 with the grip member 10 attached to the body 2 makes it possible to satisfy the grasping performance, the portability, and the operability simultaneously for improvement of the convenience for a user.

In particular, in the small-sized body 2, a space between a bump of a gripping portion and the lens barrel 3 is narrow, which makes it difficult to insert a finger therein. Further, the plate-like body 2 is difficult to hold because a gripping portion is not bulgy. As described above, the image pickup device 1 having the small-sized or plate-like body 2 still has room for improvement in terms of the easiness of grasping, and thus the grip member 10 is applicable suitably. Also, from a viewpoint of an increase in the number of buttons (increase in the button placement density) that is commensurate with the complicated operation system in addition to miniaturization of the body 2 in line with advances in the device technology, the grip member 10 exhibits the high effectiveness.

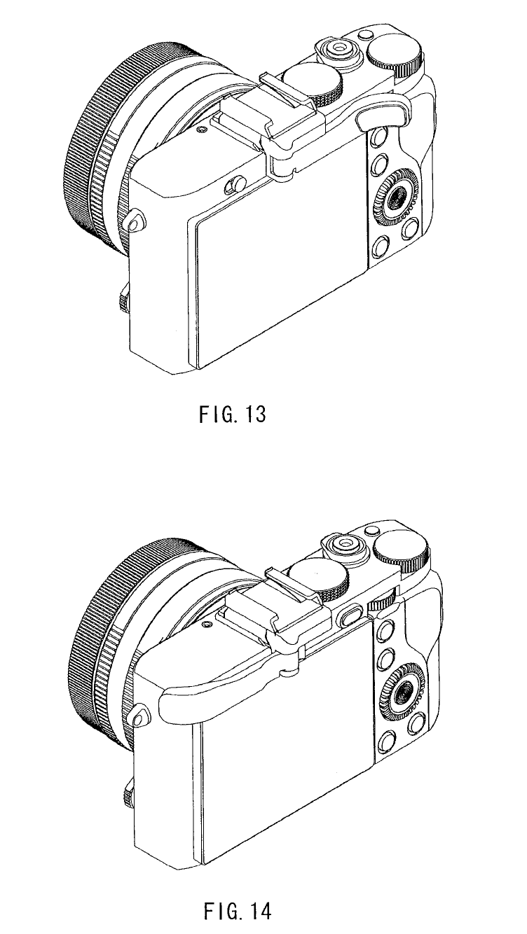

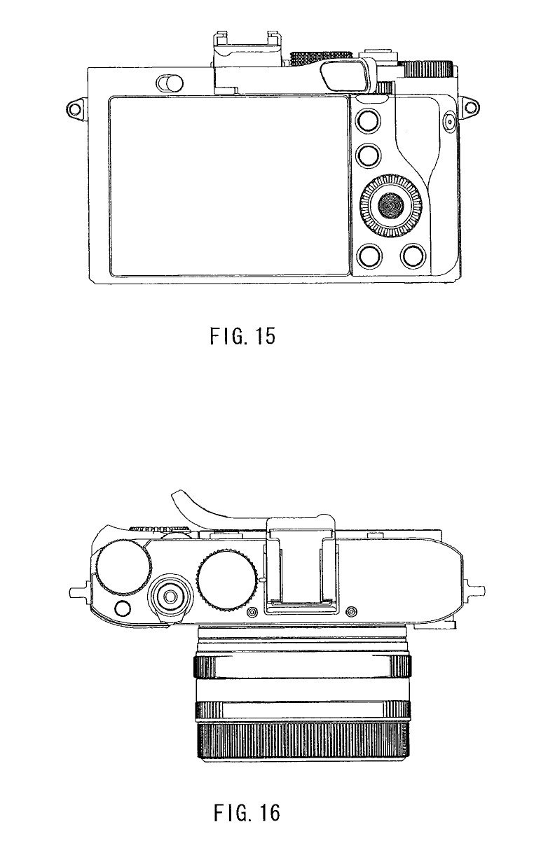

Each of FIG. 13 to FIG. 16 shows an example for an external view of the image pickup device according to the above-described embodiment of the present disclosure. FIG. 13 is a first perspective view in a case where the image pickup device is seen from the rear side. FIG. 14 is a second perspective view in a case where the image pickup device is seen from the rear side. FIG. 15 is a rear view, and FIG. 16 is a top view of the image pickup device.

The present technology is described thus far with reference to the example embodiment thereof, although the present technology is not limited to the above-described embodiment, but different variations are available. For example, in the above-described embodiment of the present disclosure, the descriptions are provided on the case where the extension section 40 is capable of moving pivotally around the linkage section 30 as the axis Al, although examples of a displacement method of the extension section 40 may include a stretching or reciprocating movement in the horizontal direction, a reciprocating movement in the vertical direction, and the like apart from a pivotal movement.

Further, for example, in the above-described embodiment of the present disclosure, the descriptions are provided on the case where the linkage section 30 is provided to extend from the left end 21A of the side 21 on the attachment section 20 when viewed from the backside of the insertion direction A3 into the accessory shoe 5 on the attachment section 20 as shown in FIG. 2 and FIG. 3. However, the linkage section 30 may be also provided to extend from a right end of the side 21 on the attachment section 20 when viewed from the backside of the insertion direction A3 into the accessory shoe 5 on the attachment section 20.

Moreover, for example, in the above-described embodiment of the present disclosure, the descriptions are provided on the case where given that a plane including the attachment section 20 is the X-Z plane, the linkage section 30 (axis A1) is provided in the vertical direction (Y direction), and the extension section 40 moves pivotally in the horizontal direction (X-Z in-plane direction). However, the linkage section 30 (axis Al) may be also provided in the horizontal direction (X direction) along the side 21 on the attachment section 20, and the extension section 40 may move pivotally in the vertical direction (Y-Z in-plane direction) alternatively.

Additionally, for example, in the above-described embodiment of the present disclosure, the descriptions are provided on the case where the finger-holding section 41 has a curved form, although the finger-holding section 41 may be flat to allow a thumb to be held mostly by the nonslip section 42.

Further, for example, in the above-described embodiment of the present disclosure, the descriptions are provided on the case where the specific position P3 corresponds with the shutter button 6, although any operation button other than the shutter button 6 may be provided at the specific position P3.

Furthermore, for example, in the above-described embodiment of the present disclosure, the descriptions are provided on the case where the grip member 10 is a component part that is separated from the body 2, and the attachment section 20 is mounted on the body 2 in a detachable manner. However, a configuration may be also permitted where the grip member 10 is fixed to, or integrated with the body 2 in an undetachable manner. Also in this case, the grip member 10 may be attached on the top face 2E of the body 2, and may have the extension section 40 capable of being displaced with respect to the body 2, which makes it possible to improve the easiness to grasp the body 2 without disturbing operation of the body 2. Further, the grip member 10 may have the attachment section 20 that is fixed to, or integrated with the body 2, as well as the linkage section 30 to link the attachment section 20 with the extension section 40.

Moreover, for example, in the above-described embodiment of the present disclosure, the descriptions are provided on the case where the display section 4 is configured of a liquid crystal or organic EL element, although the display section 4 may use any other alternative display element, such as plasma, inorganic EL, electrodeposition, or electrochromic element, apart from the liquid crystal or organic EL element.

Additionally, for example, in the above-described embodiment of the present disclosure, the descriptions are provided on the compact digital camera (digital still camera) as an example of the image pickup device 1, although the present technology may be also applicable to any other image pickup device, such as a lens-exchange camera, a video camcorder, and the like.

Furthermore, the grip member 10 according to the above-described embodiment of the present disclosure is not limited to the attachment to the body 2 (camera) of the image pickup device 1, but may be attachable to any other camera-related and peripheral component parts that have an accessory shoe, such as a bracket, a slave unit, and the like.

Furthermore, the technology encompasses any possible combination of some or all of the various embodiments described herein and incorporated herein.

It is possible to achieve at least the following configurations from the above-described example embodiments of the disclosure.
(1) A grip member, including:

an attachment section to be attached to a body;

an extension section configured to be displaceable with respect to the body; and

a linkage section linking the attachment section with the extension section.
(2) The grip member according to (1), wherein the extension section is configured to pivot around the linkage section as an axis.
(3) The grip member according to (2), wherein

the linkage section extends from one end of a side of the attachment section in a direction intersecting with the attachment section, and

the extension section is configured to pivot around the linkage section as the axis between a first position and a second position, the first position overlapping with the side of the attachment section, and the second position overlapping with an extension line of the side of the attachment section.
(4) The grip member according to any one of (1) to (3), wherein the attachment section is configured to be mounted on a top face of the body.
(5) The grip member according to (4), wherein the attachment section is configured to be mounted detachably on the body.
(6) The grip member according to (4) or (5), wherein

the body includes an accessory shoe on the top face of the body, and

the attachment section is configured to be inserted into the accessory shoe to be mounted on the top face of the body.
(7) The grip member according to (6), wherein the linkage section extends from a left end of the side of the attachment section, when viewed from backside of a direction in which the attachment section is to be inserted into the accessory shoe.
(8) The grip member according to (6) or (7), wherein the attachment section includes a lock mechanism that prevents drop-off from the accessory shoe.
(9) The grip member according to any one of (3) to (8), wherein the body includes:

a first operation section that is left open when the extension section is located at the first position, and is hidden by the extension section when the extension section is located at the second position; and

a second operation section that is left open when the extension section is located at the second position, and is hidden by the extension section when the extension section is located at the first position.
(10) The grip member according to (9), wherein

the first operation section includes a flash operation button, and

the second operation section includes a playback button and an electronic dial.
(11) The grip member according to any one of (3) to (10), further including a restricting section configured to hold the extension section at the first position, the restricting section including a convex portion and a concave portion, the convex portion being provided at one of the linkage section and the extension section, the concave portion being provided at the other one of the linkage section and the extension section, and the convex portion being fitted into the concave portion when the extension section is located at the first position.
(12) The grip member according to any one of (3) to (11), wherein the extension section includes a finger-holding section at a front edge of a movable side, the finger-holding section being located at a position closer to the linkage section than a specific position when the extension section is located at the first position, and the specific position being located on a face on the body where the attachment section is to be mounted.
(13) The grip member according to (12), wherein

the attachment section is configured to be mounted on a top face of the body, and

the specific position corresponds with a shutter button.
(14) The grip member according to (12) or (13), wherein the finger-holding section has a curved form that fits in with an outline of the body when the extension section is located at the second position.
(15) The grip member according to any one of (12) to (14), wherein the finger-holding section includes a nonslip section.
(16) An image pickup device, including:

a body; and

a grip member configured to be mounted on a top face of the body and including an extension section, the extension section being configured to be displaceable with respect to the body.
(17) The image pickup device according to (16), wherein

the body includes a display section at a rear face of the body, and

a range of displacement of the extension section lies above the display section in the rear face of the body.
(18) The image pickup device according to (16) or (17), wherein the grip member includes:

an attachment section configured to be attached to the body; and

a linkage section linking the attachment section with the extension section.

The present disclosure contains subject matter related to that disclosed in Japanese Priority Patent Application JP 2012-198595 filed in the Japan Patent Office on Sep. 10, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A grip member, comprising:
an attachment section to be attached to a body;
an extension section configured to be displaceable with respect to the body; and
a linkage section linking the attachment section with the extension section.

2. The grip member according to claim 1, wherein the extension section is configured to pivot around the linkage section as an axis.

3. The grip member according to claim 2, wherein
the linkage section extends from one end of a side of the attachment section in a direction intersecting with the attachment section, and
the extension section is configured to pivot around the linkage section as the axis between a first position and a second position, the first position overlapping with the side of the attachment section, and the second position overlapping with an extension line of the side of the attachment section.

4. The grip member according to claim 1, wherein the attachment section is configured to be mounted on a top face of the body.

5. The grip member according to claim 4, wherein the attachment section is configured to be mounted detachably on the body.

6. The grip member according to claim 4, wherein
the body includes an accessory shoe on the top face of the body, and
the attachment section is configured to be inserted into the accessory shoe to be mounted on the top face of the body.

7. The grip member according to claim 6, wherein the linkage section extends from a left end of the side of the attachment section, when viewed from backside of a direction in which the attachment section is to be inserted into the accessory shoe.

8. The grip member according to claim 6, wherein the attachment section includes a lock mechanism that prevents drop-off from the accessory shoe.

9. The grip member according to claim 3, wherein the body includes:
a first operation section that is left open when the extension section is located at the first position, and is hidden by the extension section when the extension section is located at the second position; and
a second operation section that is left open when the extension section is located at the second position, and is hidden by the extension section when the extension section is located at the first position.

10. The grip member according to claim 9, wherein
the first operation section includes a flash operation button, and
the second operation section includes a playback button and an electronic dial.

11. The grip member according to claim 3, further comprising a restricting section configured to hold the extension section at the first position, the restricting section including a convex portion and a concave portion, the convex portion being provided at one of the linkage section and the extension section, the concave portion being provided at the other one of the linkage section and the extension section, and the convex portion being fitted into the concave portion when the extension section is located at the first position.

12. The grip member according to claim 3, wherein the extension section includes a finger-holding section at a free end, the finger-holding section being located at a position closer to the linkage section than a specific position when the extension section is located at the first position, and the specific position being located on a face on the body where the attachment section is to be mounted.

13. The grip member according to claim 12, wherein
the attachment section is configured to be mounted on a top face of the body, and
the specific position corresponds with a shutter button.

14. The grip member according to claim 12, wherein the finger-holding section has a curved form that fits in with an outline of the body when the extension section is located at the second position.

15. The grip member according to claim 12, wherein the finger-holding section includes a nonslip section.

16. An image pickup device, comprising:
a body; and
a grip member configured to be mounted on a top face of the body and including an extension section, the extension section being configured to be displaceable with respect to the body.

17. The image pickup device according to claim 16, wherein
the body includes a display section at a rear face of the body, and a range of displacement of the extension section lies above the display
section in the rear face of the body.

18. The image pickup device according to claim 16, wherein the grip member includes:
an attachment section configured to be attached to the body; and
a linkage section linking the attachment section with the extension section.
